(19) United States
(12) Patent Application Publication
(10) Pub. No.: US 2004/0224702 A1
(43) Pub. Date: Nov. 11, 2004

(54) System and method for access control in the delivery of location information

(75) Inventor: Hemant Chaskar, Woburn, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/434,561

(22) Filed: May 9, 2003

(51) Int. Cl. H04M 1/66; H04M 1/68

(52) U.S. Cl. 455/456.3; 455/411

(57) ABSTRACT

A system and method are provided for access controlled delivery of location information. The system includes a mobile station, a location services client, and a location server. The mobile station is capable of receiving consent to deliver location information regarding the mobile station and, if consent is granted, automatically creating an authorization. After creating the authorization, the location services client is capable of receiving the authorization. The location services client can then transmit a request for the location information, where the request includes the authorization. The location server, in turn, can verify the authorization. After the authorization has been verified, the location server can deliver the location information to the location services client if the authorization is verified.

### FIELD OF THE INVENTION

The present invention relates generally to systems and methods for providing location information regarding a mobile station and, more particularly, relates to systems and methods for access control in the delivery of location information regarding a mobile station.

### BACKGROUND OF THE INVENTION

In many wireless communication networks and other mobile networks, the network keeps track of the location of mobile stations, such as mobile telephones, at least on a cell level. In such networks, it is typically also possible to determine the geographical location of the mobile stations, and deliver the geographical location to a requesting entity, according to various well known techniques. For example, the Mobile Location Protocol (MLP), developed by the Location Interoperability Forum (LIF), provides one such technique for the delivery of location information. For more information on the MLP, see the LIF technical specification TS 101 entitled: Mobile Location Protocol, the contents of which are hereby incorporated by reference in its entirety. Information regarding the location of the mobile stations can be utilized for a number of different purposes, such as for routing and charging, as well as for support of location services.

Various service announcements can be transmitted to mobile stations on the basis of a service request of a subscriber in mobile communication systems. Generally, these chargeable services are most often arranged to be provided from outside the actual mobile communication system. By making a call to a required service number or sending a request over the Internet, for example, a mobile subscriber is able to order a selected service announcement to be delivered to the display of the mobile station, for example. Of these individual services, e.g., weather forecast, traffic announcements, local news and other local services, such as taxi ordering and service station announcements and so on are services where the mobile subscriber selects the desired announcement on the basis of the geographical area. The mobile subscriber generally wishes to have the service announcement related to his/her current location which varies because of the mobile nature of the mobile subscriber.

Typically, mobile networks are configured such that an entity requesting the location of a mobile station, sometimes referred to as a LoCation Services (LCS) client, must have consent from the mobile station, or more particularly the user of the mobile station, before the entity may receive the location information. According to one technique for providing such authorization, referred to as proactive access control, controlling access to location information is accomplished using authorizations that are pre-programmed by the user of the mobile station. This pre-authorization information may reside on, or be accessible to, a Location Server (LS) responsible for delivering location information regarding the mobile station to requesting LCS clients. Whereas proactive access control provides adequate control for access to such location information, the proactive access control technique requires the requesting LCS client to be previously pre-programmed by the user. In this regard, if the user of the mobile station desires to access a location-based service on an LCS client that is not in the pre-programmed authorization list, the LS will not provide the mobile station's location to the LCS client, thus preventing delivery of the location-based service.

According to another technique for controlling access to location information, referred to as the reactive method, the user of the mobile station is explicitly prompted for consent to deliver the location information before providing the location information to the requesting LCS client. For example, presume that the user of the mobile station desires to access a location-based service, such as receiving weather information based upon the location of the mobile station, and thus the user of the mobile station. Upon selecting the location-based service, a request for the location-based service is transmitted to the LCS client. In turn, the LCS client queries an LS for location information regarding the mobile station. The LS prompts the user of the mobile station for consent, and upon granting consent, the LS provides the location information to the LCS client. The LCS client can then provide the location-based service to the mobile station. The reactive method of access control addresses the problem of pre-programming an access control list suffered by proactive access control. However, the reactive method of access control requires additional messaging for prompting the user for consent, which results in increased wireless link bandwidth consumption, as well as increased response time in providing the location-based service.

### SUMMARY OF THE INVENTION

In light of the foregoing background, embodiments of the present invention provide an improved system and method for access control in the delivery of location information regarding a mobile station. Embodiments of the present invention provide an authorization method for access control to location information that reduces the overhead of consent messaging compared to the reactive method. In addition, embodiments of the present invention allow the user of a mobile station to consent to an LCS client receiving location information regarding the mobile station, without requiring the user to preprogram the LCS client into an access control list.

According to one aspect of the present invention, a system is provided for access controlled delivery of location information. The system includes a mobile station, a location services client, and a location server. The mobile station is capable of receiving consent, such as from a user, to deliver location information regarding the mobile station. Before receiving the consent, however, the mobile station can receive a request for a location-based service, which can trigger a prompt. Advantageously, the mobile station is capable of automatically creating an authorization upon receiving the consent, and thereafter transmitting the authorization. After creating the authorization, the location services client is capable of receiving the authorization. The location services client can then transmit a request for the location information, where the request includes the authorization. The location server, in turn, can verify the authorization. The mobile station can be capable of receiving consent with at least one parameter including a predefined granularity, frequency and/or time period. In such instances, the mobile station is capable of creating the authorization to include the parameters. In turn, the location server can be capable of verifying that the predefined accuracy and/or time period has not been exceeded. Additionally, the location server may be capable of verifying the authorization by verifying a shared secret between the mobile station and the location server.

After the authorization has been verified, the location server can deliver the location information to the location services client if the authorization is verified. In this regard, the location server can deliver the location information with a predefined granularity. More particularly, the system can also include a position determining entity capable of determining the location information. In this regard, the location information can include a set of geographic coordinates representative of a location of the mobile station. The system can further include a mapping processor capable of mapping the geographic coordinates into logical coordinates representative of a location of the mobile station. In such an instance, the location information delivered by the location server includes the logical coordinates.

A mobile station and method of access control are also provided. Embodiments of the present invention therefore provide an improved system and method for access control of location information. By creating and including an authorization in a request for a location-based service, embodiments of the present invention reduce the overhead of consent messaging compared to the reactive method since a separate authorization need not be transmitted from the location server to the mobile station. In addition, because the authorization is transmitted from the mobile station, embodiments of the present invention allow the user of a mobile station to consent to an LCS client receiving location information without requiring the user to preprogram the LCS client identity into an access control list. Therefore, the systems and methods of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a wireless communications system according to one embodiment of the present invention including a cellular network and a data network to which the mobile station is bi-directionally coupled through wireless RF links;

FIG. 2 is a schematic block diagram of a mobile station according to one embodiment of the present invention;

FIG. 3 is a control flow diagram illustrating conventional proactive and reactive methods of access control;

FIG. 4 is a control flow diagram illustrating a method of access control according to one embodiment of the present invention;

FIG. 5 is a flow chart illustrating various steps in a method of access control according to one embodiment of the present invention; and

FIG. 6 is a control flow diagram illustrating a method of access control according to another embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

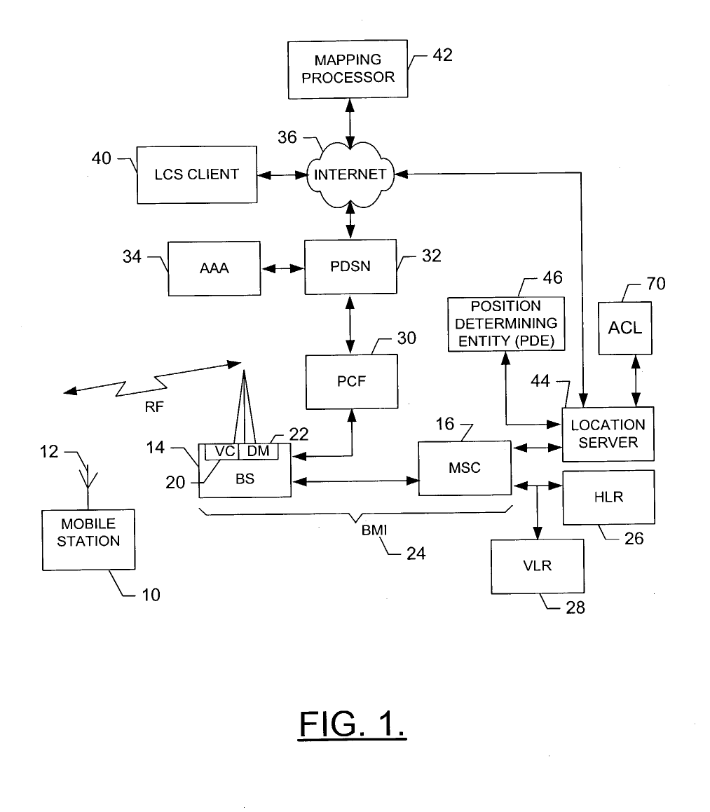

Referring to FIG. 1, an illustration of one type of wireless communications network including a terminal, such as a mobile station 10, that would benefit from the present invention is provided. It should be understood, however, that the mobile telephone illustrated and hereinafter described is merely illustrative of one type of mobile station that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers and other types of voice and text communications systems, can readily employ the present invention. Moreover, the system and method of the present invention will be primarily described in conjunction with mobile communications applications. But the system and method of the present invention can be utilized in conjunction with a variety of other applications, both in the mobile communications industries and outside of the mobile communications industries.

In addition, while several embodiments of the system and method of the present invention include a terminal comprising a mobile station 10, the terminal need not comprise a mobile station. Moreover, the system and method of the present invention will be primarily described in conjunction with mobile communications applications. It should be understood, however, that the system and method of the present invention can be utilized in conjunction with a variety of other applications, both in the mobile communications industries and outside of the mobile communications industries.

As shown, the mobile station 10 includes an antenna 12 for transmitting signals to and for receiving signals from a base site or base station (BS) 14. The base station is a part of a cellular network that includes a mobile switching center (MSC) 16, voice coder/decoders (vocoders) (VC) 20, data modems (DM) 22, and other units required to operate the network. The MSC is capable of routing calls and messages to and from the mobile station when the mobile station is making and receiving calls. As indicated above, the cellular network may also be referred to as a Base Station/MSC/Interworking function (BMI) 24. The MSC controls the forwarding of messages to and from the mobile station when the station is registered with the network, and also controls the forwarding of messages for the mobile station to and from a message center (not shown). Such messages may include, for example, voice messages received by the MSC from users of Public Switched Telephone Network (PSTN) telephones, and may also include Short Message Service (SMS) messages and voice messages received by the MSC from the mobile station or other mobile terminals serviced by the network.

Subscriber data of a mobile station 10 is stored permanently in a Home Location Register (HLR) 26 of the system and temporarily in the Visitor Location Register (VLR) 28 in the area of which the mobile station is located at a given moment. In this regard, the VLR contains selected administrative information necessary for call control and provision of the subscribed services for each mobile station currently located in the geographical area controlled by the VLR. Although each functional entity can be implemented as an independent unit, manufacturers of switching equipment generally implement the VLR together with the MSC 16 so that the geographical area controlled by the MSC corresponds to that controlled by the VLR, thus simplifying the signaling required. As such, the MSC and VLR will collectively be referred to herein as the MSC/VLR. The HLR contains the identity of the wireless network (usually in the form of an MSC number) where the mobile station is currently attached. In this regard, the HLR resides in the home network of the mobile network. Various entities, such as the HLR, MSC, message center, and so forth, are connected via SS7 signaling network.

The mobile station 10 can also be coupled to a data network. For example, the base station BS 14 can be connected to a packet control function (PCF) 30, which is in connection with a Packet Data Serving Node (PDSN) 32. The PDSN is preferably connected to an AAA server 34, which provides Authentication, Authorization, and Accounting services. The AAA server can comprise a Remote Access Dialup User Service (RADIUS) server, as will be appreciated by those skilled in the art. The PDSN can also be connected to a wide area network, such as the Internet 36. In turn, devices such as processing elements (e.g., personal computers, server computers or the like) can be coupled to the mobile station via the PDSN. For example, the processing elements can include one or more processing elements associated with a location services (LCS) client 40, as well as one or more processing elements associated with a mapping processor 42, both of which are illustrated in FIG. 1 and described more fully below. By directly or indirectly connecting both the mobile station 10 and the other devices to the PDSN and the Internet, the mobile station can communicate with the other devices, such as according to the Internet Protocol (IP) specification, to thereby carry out various functions of the mobile station.

The MSC 16 is coupled to a location server (LS) 44 providing location services for different applications or LCS clients 40 (only one client shown for clarity). In general terms, the LS can be defined as an entity capable of providing information concerning the geographical location of the mobile station 10. In this regard, the LS may be coupled to a position determining entity 46 capable of determining the location information provided by the LS. The geographical location may be defined on the basis of the position of the mobile station relative to the base station 14 of the wireless communications network.

The geographical location of the base station 14 and/or the mobile station 10 may be defined, for example, in X and Y coordinates or in latitudes and longitudes. A possibility is to use the relation between defined radiuses and angles, e.g. based on the spherical coordinate system or the like. It is also possible to define the location of the base stations and/or mobile stations in vertical directions. For example, Z coordinate may be used when providing the location information in the vertical direction. The vertical location may be needed such as to define the location in mountainous environments or in cities with tall buildings.

The LS 44 can comprise any of a number of known elements in the wireless communications network such as, for example, a gateway mobile location center (GMLC), as defined by the GSM specification. The LS is typically arranged to receive a request for location information, such as from an LCS client 40. If the LCS client is authorized to receive the location information, then, the LS can initiate determining the location of the mobile station, such as by the position determining entity 46. In this regard, the position determining entity is adapted to receive via appropriate interface means predefined information concerning the location of the mobile station 10. The position determining entity is adapted to process the information in order to determine the geographical location of the mobile station. The information received by the LS, and thereafter passed to the position determining entity to initiate determining the location of the mobile station, may include the identity of the mobile station, such as an international mobile subscriber identifier (IMSI), or a temporary identifier, such as a temporary international mobile subscriber identifier (TIMSI).

The LS 44 and/or position determining entity 46 may be implemented in the core network and be arranged to receive location information from the wireless communication network via the MSC 16 and/or a serving general packet radio service support node (SGSN) (not shown). The location information may be determined by communication between the wireless communication network and the mobile station according to one or more appropriate techniques, such as triangulation, Global Positioning System (GPS), Assisted GPS (A-GPS), Time of Arrival (TOA), Observed Time Difference of Arrival (OTDOA) or the like, as such are well known to those skilled in the art. This information may be processed in a predefined manner and then provided to the LS, which can forward the information to the LCS client 40, such as via the Internet 36.

It should be appreciated that the elements of the LS 44 and/or the position determining entity 46 functionality may be implemented anywhere in the wireless communications network. The LS and/or the position determining entity implementation may also be distributed between several elements of the network. Alternatively, the LS and the position determining entity implementation may be implemented in a single element. For example, the LS may include, and thus perform the functions, of the position determining entity, as well as the functions of the LS. The LS may also be an external node to the wireless communications network. According to one embodiment, for example, the mobile station or user equipment provides the LS. The mobile station is provided with the LS processing function and is capable of generating and transporting location information thereof to the LCS client 40. The mobile station may be provided with terminal equipment apparatus (either integrated in the mobile station device or connected thereto). The location information may be based on use of information provided by a system that is separate from the communication system, such as by means of a Global Positioning System (GPS) or similar system.

The LS 44 may consist of a number of location service components and bearers needed to serve the LCS client 40. The LS may provide a platform which will enable the support of location based services in parallel with other wireless communication services such as speech, data, messaging, other tele-services, user applications and supplementary services. The LS may respond to a location request from a properly authorized LCS client 40 with location information (determined by the position determining entity 46) for the target mobile station 10 specified by the LCS client if considerations of target mobile station privacy are satisfied, as described below. The LS may therefore provide the LCS client, on request or periodically, the current or most recent geographic location (if available) of the target mobile station or, if the location determination fails, an error indication and optionally the reason for the failure. A more detailed description of a LS that may be employed in the embodiments of the present invention can be found in the European telecommunications Standards Institute (ETSI) technical specification entitled “Location Services” (3GPP TS23.171 and GSM 03.71).

More particularly as to the LCS client 40, the LCS client is a logical functional entity that may make a request to the entity providing the location service function, such as the LS 44 or the mobile station 10, for the location information of one or more target mobile stations. The LCS client may be an entity that is external to the wireless communication network, as shown in FIG. 1 (coupled to the wireless communication network via the data network). The LCS client may alternatively be an internal client (ILCS), i.e., reside in any entity or node (including the mobile station) within the wireless communication network. The LCS clients are entitled to receive at least some degree of information concerning the location (or location history) of the mobile station.

The particular requirements and characteristics of the LCS client 40 are typically known to the LS 44 by its LCS client subscription profile. The particular LCS-related restrictions associated with each target mobile station may also be detailed in the target mobile station subscription profile. The location service feature may permit the location of a target mobile station to be determined at any time.

The location information received by the LCS client 40 may be used for any of a number of different purposes. For example, the LCS client may transmit location-related information to the mobile station 10 in a particular geographic area, such as on weather, traffic, hotels, restaurants, or the like. Also, for example, the LCS client may record anonymous location information (i.e., without any mobile station identifier), such as for traffic engineering and statistical purposes. Further, the LCS client may enhance or support any of a number of supplementary services, such as an intelligent network (IN) service, bearer service and/or tele-service subscribed to by the mobile station subscriber.

The location information can of course be used to determine the location of a mobile station 10 when the mobile station makes an emergency call. There are also several other possible commercial and non-commercial applications that may use the location information. Such possible applications include different local advertisement and information distribution schemes (e.g. transmission of information directed to those mobile users only who are currently within a certain area), area related WWW-pages (such as time tables, local restaurant, shop or hotel guides, maps, local advertisements etc.) for the users of mobile data processing devices, and tracking of mobile users by anyone who wishes to receive this information and is legally entitled to obtain it. An application requiring real-time location information of the movement of a mobile station is a mobile station movement prediction feature that the wireless communication network may utilize, for example, in dynamic network resource allocation. There are still various other possible uses of the location information and applications that would benefit from the location information.

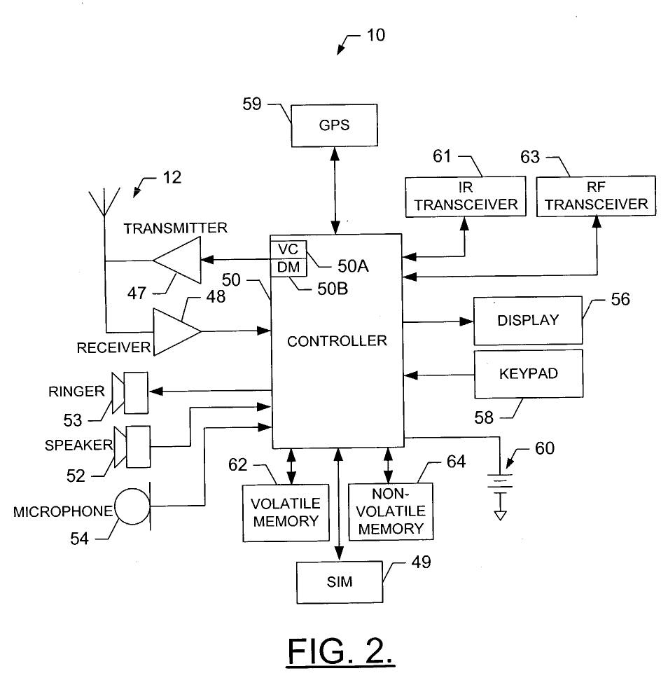

Reference is now drawn to FIG. 2, which illustrates a block diagram of a mobile station 10 that would benefit from the present invention. The mobile station includes a transmitter 47, a receiver 48, and a controller 50 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first, second and/or third-generation communication protocols or the like. For example, the mobile station may be capable of operating in accordance with second-generation (2G) wireless communication protocols IS-136 (TDMA), GSM, and IS-95 (CDMA). Some narrow-band AMPS (NAMPS), as well as TACS, mobile terminals may also benefit from the teaching of this invention, as should dual or higher mode phones (e.g., digital/analog or TDMA/CDMA/analog phones).

It is understood that the controller 50 includes the circuitry required for implementing the audio and logic functions of the mobile station 10. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 50A, and may include an internal data modem (DM) 50B. Further, the controller 50 may include the functionally to operate one or more software programs, which may be stored in memory. For example, the controller may be capable of operating a connectivity program, such as a conventional Web browser. The connectivity program may then allow the mobile station to transmit and receive Web content, such as location-based content from the LCS client 40, according to the Wireless Application Protocol (WAP), for example. Also, for example, the controller may be capable of operating a software application capable of creating an authorization for delivery of location information regarding the mobile station, in accordance with embodiments of the present invention (described below).

The mobile station 10 also comprises a user interface including a conventional earphone or speaker 52, a ringer 53, a microphone 54, a display 56, and a user input interface, all of which are coupled to the controller 50. The user input interface, which allows the mobile station to receive data, can comprise any of a number of devices allowing the mobile station to receive data, such as a keypad 58, a touch display (not shown) or other input device. In embodiments including a keypad, the keypad includes the conventional numeric (0-9) and related keys (#, *), and other keys used for operating the mobile station.

The mobile station further includes a battery 60, such as a vibrating battery pack, for powering the various circuits that are required to operate the mobile station, as well as optionally providing mechanical vibration as a detectable output, as described below. In addition, the mobile station can include a positioning sensor, such as a global positioning system (GPS) sensor 59. In this regard, the GPS sensor is capable of determining a location of the mobile station, such as longitudinal and latitudinal directions of the mobile station.

The mobile station 10 can also include memory, such as a subscriber identity module (SIM) 49, a removable user identity module (R-UIM) or the like, which typically stores information elements related to a mobile subscriber. In addition to the SIM, the mobile station 10 can include other memory. In this regard, the mobile station can include volatile memory 62, such as volatile Random Access Memory (RAM) including a cache area for the temporary storage of data. The mobile station can also include other non-volatile memory 64, which can be embedded and/or may be removable. The non-volatile memory can additionally or alternatively comprise an EEPROM, flash memory or the like, such as that available from the SanDisk Corporation of Sunnyvale, California, or Lexar Media Inc. of Fremont, Calif. The memories can store any of a number of pieces of information, and data, used by the mobile station to implement the functions of the mobile station. For example, the memories can include an identifier, such as an international mobile equipment identification (IMEI) code, capable of uniquely identifying the mobile station 10, such as to the MSC 16.

The mobile station 10 can further include an infrared transceiver 61 or another local data transfer device so that data can be shared with and/or obtained from other devices such as other mobile stations, car guidance systems, personal computers, printers, printed materials including barcodes and the like. The sharing of data, as well as the remote sharing of data, can also be provided according to a number of different techniques. For example, the mobile station may include a radio frequency transceiver 63 capable of sharing data with other radio frequency transceivers, and/or with a Radio Frequency Identification (RFID) transponder tag, as such is known to those skilled in the art. Additionally, or alternatively, the mobile station may share data using Bluetooth brand wireless technology developed by the Bluetooth Special Interest Group. Further, although not shown, the mobile station may include a barcode reader such that the mobile station may receive data according to barcode data transfer techniques.

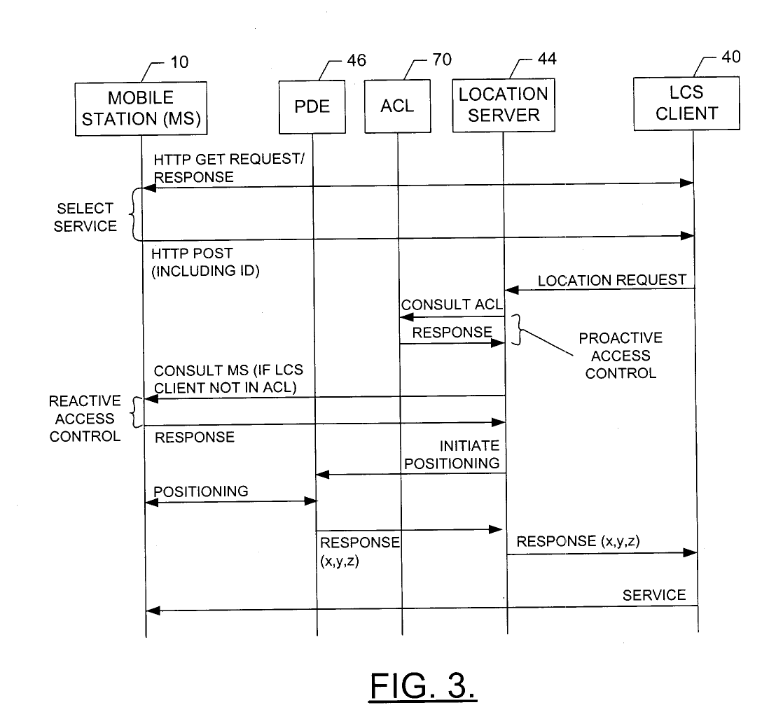

As indicated in the background section, typically mobile networks are configured such that the LCS client 40 requesting the location of a mobile station must have consent from the mobile station 10, or more particularly the user of the mobile station, before the LCS client may receive the location information. In this regard, reference is now made to FIG. 3, which illustrates a control flow diagram according to exemplar methods of providing proactive and/or reactive access control in the context of delivering location-based services. As shown, the user of the mobile station can operate a Web browser to download a conventional Web page from an LCS client 40, such as by transmitting an HTTP GET request and receiving a response. Presuming the Web page includes a hypertext link to a location-based service, such as location-based weather information, the user can initiate receiving the service by selecting the respective hypertext link. Upon selecting the link, a request for the service is transmitted, along with an identifier (ID) of the mobile station (e.g., IMSI) to the LCS client, such as via an HTTP POST.

Upon receiving the request for the location-based service from the mobile station 10, the LCS client 40 queries the LS 44 for location information regarding the mobile station, such as in accordance with MLP. According to proactive access control, the LS then consults an access control list (ACL) 70 of one or more preprogrammed authorizations for specified LCS clients. In this regard, the ACL may comprise a database controlled by, or otherwise in communication with, the LS that includes a list of authorized LCS clients for one or more mobile stations. Upon receiving a response from the ACL, and presuming the LCS client is listed in the ACL, the LS initiates positioning with the position determining entity (PDE) 46. If the LCS client is not listed in the ACL or if no ACL exists, as in the case of reactive access control, the LS can prompt the mobile station for consent to deliver the location information to the LCS client. Then, presuming the mobile station grants consent for delivery of the location information, the LS initiates positioning with the PDE. In either event, upon initiation of positioning, the PDE acquires the location information regarding the mobile station, and thereafter transmits the location information to the LS. Finally, the LS delivers the location information to the LCS client, which can then deliver the location-based service to the mobile station based upon the location information.

As described in the background section, although proactive and reactive methods of access control are adequate techniques for providing location information to authorized LCS clients 40, each have drawbacks. As such, according to embodiments of the present invention, the mobile station 10, and more particularly the controller 50 of the mobile station, may be capable of operating a software application to automatically generate an authorization for a given LCS client, which can then be transmitted to the LCS client along with a request for a location-based service. The LCS client can then request the location information from the LS 44 utilizing the authorization such that the LS need not separately consult an ACL 70 or the mobile station itself.

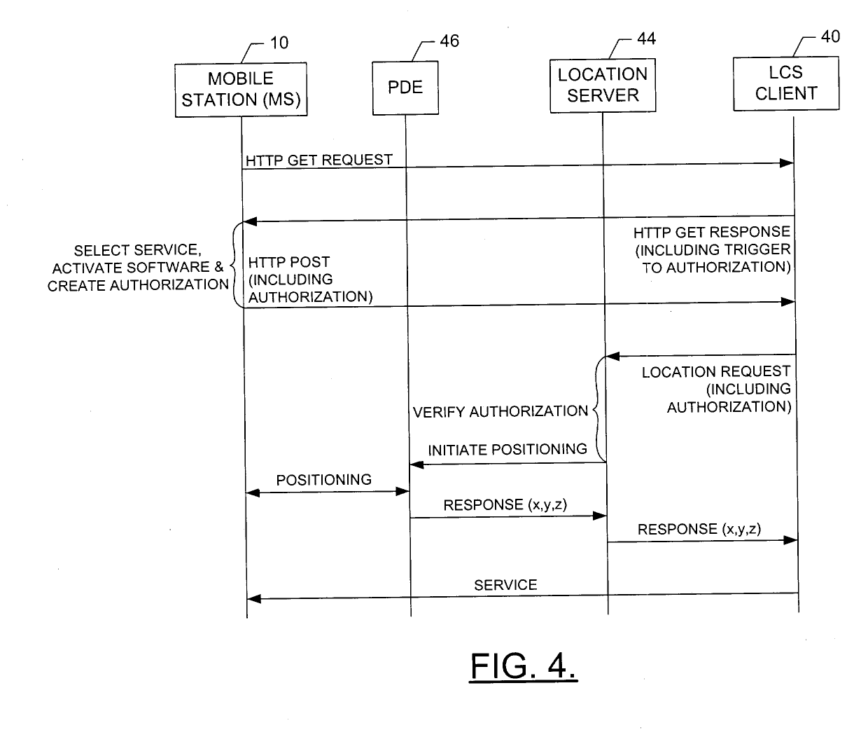

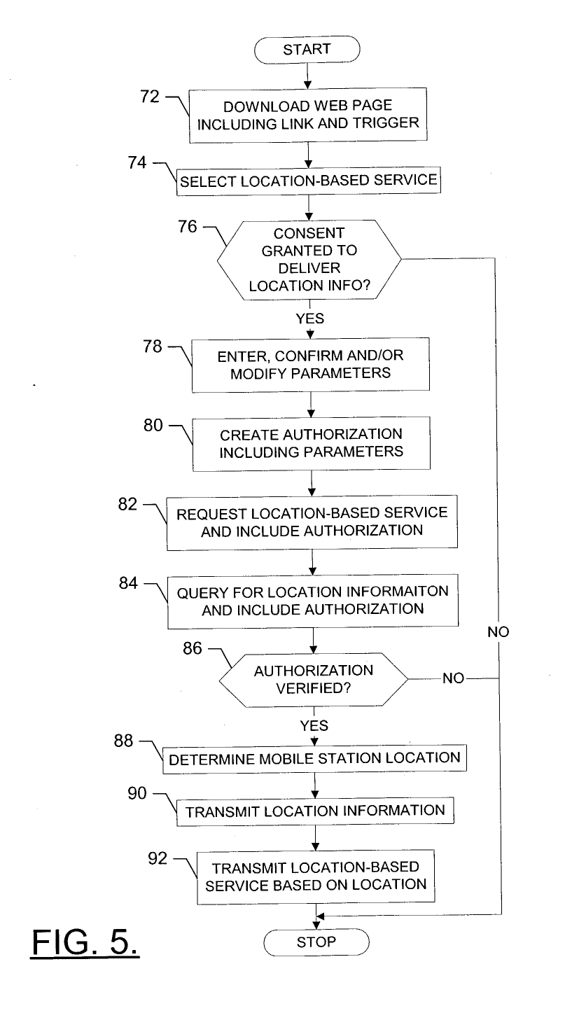

Reference is now made to FIGS. 4 and 5, which illustrate a method of access control in accordance with one embodiment of the present invention in the context of delivering location-based services. As before with the proactive and reactive methods, the user of the mobile station can operate a Web browser to download a conventional Web page from an LCS client 40, such as by transmitting an HTTP GET request to the LCS client, as shown in block 72. The response from the LCS client contains a link, such as a hypertext link, to a location-based service but, in contrast to the proactive and reactive methods, also contains a trigger associated with the link to the location-based service that, when executed, directs the controller 50 to operate the software program to create an authorization for the respective LCS client. The trigger can be embodied in any of a number of different formats, such as tags (e.g., HTML, XML, XHTML or WML tags), scripts (e.g., WML, ECMA or JAVA scripts) or the like.

In addition to causing the controller 50 to operate the software program to create the authorization, the trigger may also include parameters of the authorization, such as the granularity of the location information, the frequency with which the LCS client 40 may receive the location information and/or the time period (or expiration time) over which the LCS client may receive the location information. During operation of the software program, then, the user may be prompted to enter or confirm parameters included in the authorization. For example, the user may be prompted to enter the granularity of the location information. The user may be prompted to enter the granularity in any of a number of different manners, such as in an intuitive manner by specifying logical attributes, such as street, zip code, city, country or the like. Alternatively, the user may be prompted to enter the granularity by specifying a region in some coordinate system.

Upon receiving the Web page including the hypertext link and associated trigger, the mobile station 10 may display the Web page, and thereafter receive a selection of the location-based service, such as via the user interface of the mobile station, as illustrated in block 74. Upon receiving the selection, the associated trigger causes the controller 50 to launch and operate the software program to automatically generate an authorization for delivery of location information to the LCS client 40 so that the LCS client can deliver the location-based service to the mobile station. In one typical embodiment, the software program prompts the user for consent to deliver the location information to the LCS client, as shown in block 76. If the user does not consent to delivery of the location information, the LCS client cannot receive the location information, which typically results in the mobile station not receiving the location-based service. If the user does grant consent to delivery of the location information, however, the software application can interpret the parameters included in the trigger and display the parameters for the user to enter, confirm and/or modify, as illustrated in block 78. For example, upon granting consent for delivery of the location information, the software application may prompt the user to enter the desired granularity (e.g., current cell, exact coordinates, etc.) of the location information provided to the LCS client, and prompt the user to confirm that the LCS client may receive the location information at a frequency of once per day for a time period of one week.

Upon granting consent and receiving, confirming and/or modifying the parameters of the authorization, the software application can automatically create the authorization, as illustrated in block 80. The authorization can be created in any number of manners, but typically comprises an electronic file that authorizes the LCS client 40 to receive location information regarding the mobile station 10 based upon the parameters included in the authorization. The authorization is typically either encrypted, includes a digital signature of the mobile station, or is password protected, such that the LS 44 can subsequently verify that the authenticity of the authorization, as described below. As will be appreciated, the digital signature, encryption or password protection of the authorization by the mobile station for interpretation by the LS can be accomplished according to any of a number of known techniques.

After creating the authorization, a request for the location-based service is transmitted to the LCS client 40 along with the authorization and the ID of the mobile station 10, such as by utilizing an HTTP POST, as shown in block 82. Upon receipt of the request for the location-based service and the authorization, the LCS client formulates a query to the LS 44 to request location information regarding the mobile station. In this regard, the query includes the mobile station ID and the authorization. The query, including the authorization, is then transmitted to the LS, as illustrated in block 84.

The LS 44 receives the query, and thereafter parses the query to extract the mobile station ID and the authorization of the mobile station. In this regard, the LS can decrypt, interpret the digital signature or provide a password to the authorization, and verify that the LCS client 40 is authorized to receive location information regarding the mobile station 10, as shown in block 86. The LS can verify the authorization in any number of different manners, including verifying that the authorization came from the respective mobile station by decrypting, interpreting or providing a password associated with the authorization. Also, the LS can verify the authorization by verifying that the parameters of the authorization have been met, such as by verifying that the frequency of receiving the location information, and/or the time period for receiving the location information, has not been exceeded.

As will be appreciated, then, the LS 44 can verify the authorization by making use of a secret known only to the LS and the mobile station 10. Such a secret (e.g., a cryptographic key, password, digital signature, etc.) is typically generated and securely transmitted to the LS and the mobile station prior to the mobile station creating the authorization and the LS verifying the authorization. For example, the secret can be transmitted to the LS and the mobile station by an operator of the wireless network when the user of the mobile station subscribes to service with the wireless operator. In such an instance, the secret can be managed (refreshed, modified, etc.) at regular intervals by the wireless network operator of in a peer-to-peer manner by the LS and the mobile station.

If the authorization is not verified, the LS 44 does not deliver location information to the LCS client 40 and, may additionally, transmit a message to the LCS client informing the LCS client that the authorization was not verified. If the authorization is verified, however, the LS initiates positioning, such as by directing the position determining entity (PDE) 46 to determine the location of the mobile station 10 with the granularity specified in the parameters of the authorization, if such a granularity has been specified. In this regard, the LS can communicate with the PDE in the home network of the mobile station, when the mobile station is located in the home network. However, when the mobile station is located in a visiting network, the LS can communicate with the HLR 26 in the home network of the mobile station to determine the current visiting network of the mobile station. Then, the LS can communicate with the PDE of the visiting network of the mobile station, possibly via a chain of LS's, such that the PDE of the network in which the mobile station is currently residing can determine the location of the mobile station. In either event, once the LS initiates positioning of the mobile station, the PDE determines the location of the mobile station, such as according to any of a number of known methods, as shown in block 88. Typically, the PDE will determine the location of the mobile station having geographical coordinates, such as longitudinal, latitudinal and/or altitudinal coordinates. The PDE may, however, be capable of determining the location information in logical coordinates with the granularity specified in the parameters, such as by a given country, state, zip code, city and/or address.

Once the PDE 46 has determined the location of the mobile station 10, the PDE transmits a response to the LS 44 including the location information. In turn, the LS can deliver the location information to the LCS client 40, as shown in block 90. Then, once the LCS client receives the location information, the LCS client can reply to the mobile station request for location-based service by providing the location-based service to the mobile station based upon the location information regarding the mobile station, as illustrated in block 92.

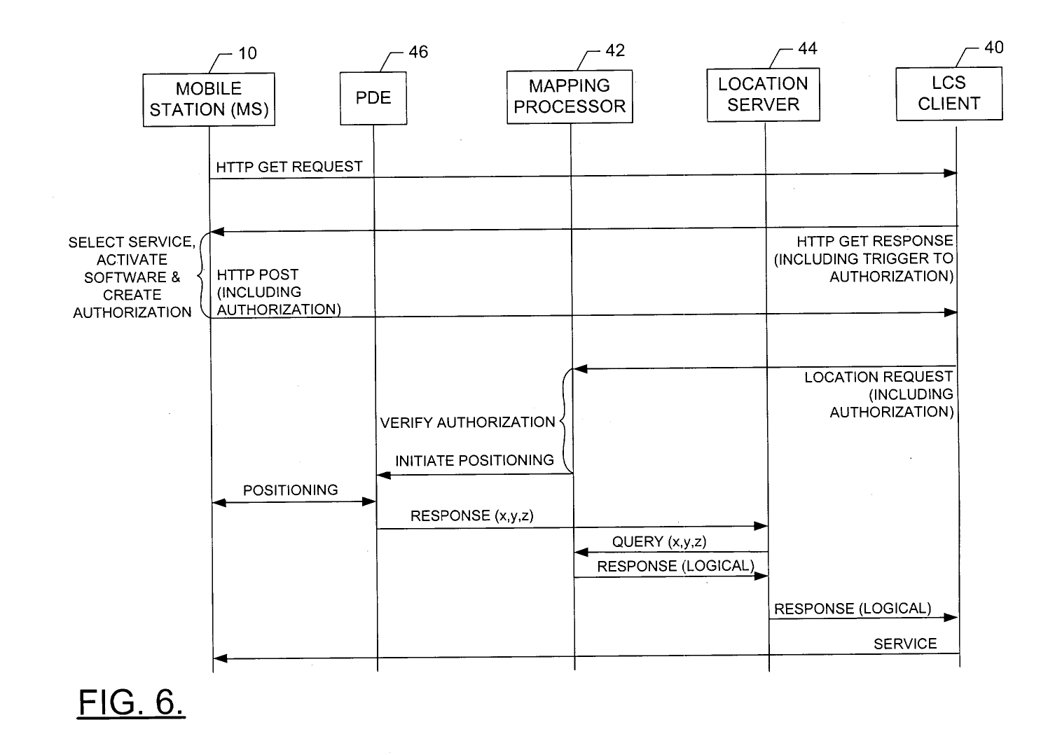

As indicated above, the PDE 46 may be capable of determining the location information in logical coordinates with the granularity specified in the parameters. In some instances, however, the PDE may not be capable of determining the location information in logical coordinates, but the mobile station 10 (via the parameters) and/or the LCS client requests the location information in logical coordinates. In such instances, as shown in FIG. 6, the LS 44 may communicate with a mapping processor 42, such as via the Internet 36, to obtain the location information in logical coordinates. In this regard, the PDE determines the location of the mobile station in geographical coordinates, and thereafter transmits the location information to the LS. In turn, the LS passes the geographical coordinate location information to the mapping processor. The mapping processor, utilizing any of a number of well known techniques, can then convert the geographical coordinates to logical coordinates. The mapping processor then returns the logical coordinate location information to the LS which, in turn, delivers the logical coordinate location information to the LCS client. The LCS client can then provide the location-based service based upon the logical coordinate location information.

The methods of embodiments of the present invention illustrated and described above with respect to FIGS. 4, 5 and 6 have been in the context of requesting location-based services. It will be appreciated, however, that the LCS client 40 may desire to receive location information regarding the mobile station 10 for a number of other purposes, some of which are described above. As such, it will also be appreciated that embodiments of the present invention can be implemented in any instance in which the mobile station locally consents to delivery of the location information, and automatically thereafter creates an authorization. The authorization can then be transmitted to the LCS client, which includes the authorization in a query to the LS 44 for the location information.

It will be appreciated that the method of embodiments of the present invention is not exclusive of the methods by which an LCS client 40 can receive controlled access to location information regarding the mobile station 10. For example, the system according to another embodiment of the present invention can include an ACL 70 as in the conventional proactive technique for access control. In such an instance, the method of embodiments of the present invention can operate to provide access control according to the proactive technique when the LCS client is located in the ACL. Then, when the LCS client is not located in the ACL, the method can continue by creating and thereafter utilizing the authorization, such as in a manner described above.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for access controlled delivery of location information regarding a mobile station, the method comprising:
receiving consent to deliver location information regarding the mobile station, and automatically thereafter creating an authorization;
transmitting a request for the location information, wherein the request includes the authorization;
verifying the authorization; and
delivering the location information if the authorization is verified.

2. A method according to claim 1 further comprising triggering a prompt to consent to delivery of location information before receiving the consent.

3. A method according to claim 2, wherein triggering a prompt comprises requesting a location-based service to thereby trigger the prompt.

4. A method according to claim 1 further comprising selecting a location-based service before receiving the consent.

5. A method according to claim 1, wherein consenting to delivery of location information comprises consenting to delivery of location information with at least one parameter including a least one of a predefined granularity, frequency and time period, and wherein creating an authorization comprises creating an authorization including the at least one parameter.

6. A method according to claim 5, wherein verifying the authorization includes verifying that at least one of the predefined accuracy and time period has not been exceeded.

7. A method according to claim 6, wherein verifying the authorization further includes verifying a shared secret.

8. A method according to claim 1, wherein delivering the location information comprises delivering the location information with a predefined granularity.

9. A method according to claim 1 further comprising:
determining the location information, wherein the location information includes a set of geographic coordinates representative of a location of the mobile station; and
mapping the geographic coordinates into logical coordinates representative of a location of the mobile station, wherein the delivered location information includes the logical coordinates.

10. A system for access controlled delivery of location information, the system comprising:
a mobile station capable of receiving consent to deliver location information regarding the mobile station, wherein the mobile station is capable of automatically creating an authorization upon receiving the consent, and thereafter transmitting the authorization;
a location services client capable of receiving the authorization, and thereafter transmitting a request for the location information, wherein the request includes the authorization; and
a location server capable of verifying the authorization, and thereafter delivering the location information to the location services client if the authorization is verified.

11. A system according to claim 10, wherein the mobile station is capable of receiving input to thereby trigger a prompt to consent to delivery of location information before receiving the consent.

12. A system according to claim 11, wherein the mobile station is capable of receiving a request for a location-based service to thereby trigger the prompt.

13. A system according to claim 10, wherein the mobile station is capable of receiving a selection of a location-based service before receiving the consent.

14. A system according to claim 10, wherein the mobile station is capable of receiving consent with at least one parameter including at least one of a predefined granularity, frequency and time period, and wherein the mobile station is capable of creating an authorization including the at least one parameter.

15. A system according to claim 14, wherein the location server is capable of verifying the authorization by verifying that at least one of the predefined accuracy and time period has not been exceeded.

16. A system according to claim 15, wherein the location server is capable of verifying the authorization by further verifying a shared secret between the mobile station and the location server.

17. A system according to claim 10, wherein the location server is capable of delivering the location information with a predefined granularity.

18. A system according to claim 10 further comprising:
a position determining entity capable of determining the location information, wherein the location information includes a set of geographic coordinates representative of a location of the mobile station; and
a mapping processor capable of mapping the geographic coordinates into logical coordinates representative of a location of the mobile station, wherein the location information delivered by the location server includes the logical coordinates.

19. A mobile station comprising:
a user interface capable of receiving consent to deliver location information regarding the mobile station;
a controller capable of executing a software application to automatically create an authorization upon receipt of the consent; and
a transmitter capable of transmitting the authorization to a location services client.

20. A mobile station according to claim 19, wherein the user interface is capable of receiving input to thereby trigger the controller to execute the software application to present a prompt to receive consent to deliver location information before the user interface receives the consent for delivery of location information.

21. A mobile station according to claim 20, wherein the user interface is capable of receiving a request for a location-based service to thereby trigger the controller.

22. A mobile station according to claim 19, wherein the user interface is capable of receiving a selection of a location-based service before receiving the consent.

23. A mobile station according to claim 19, wherein the user interface is capable of receiving consent to deliver location information with at least one parameter including at least one of a predefined granularity, frequency and time period, and wherein the software application is capable of creating the authorization including at least one of the predefined granularity, frequency and time period.
